(19) United States
(12) Patent Application Publication
(10) Pub. No.: US 2008/0219151 A1
(43) Pub. Date: Sep. 11, 2008

(54) SYSTEM AND METHOD FOR USING A PEER TO PEER MECHANISM TO REPAIR BROADCAST DATA IN WIRELESS DIGITAL BROADCAST NETWORKS

(75) Inventors: Jian J. Ma, Beijing (CN); Kuifei Yu, Xi Tu Cheng (CN); Xiaopeng LV, Xi Tu Cheng (CN)

Correspondence Address: FOLEY & LARDNER LLP, P.O. BOX 80278, SAN DIEGO, CA, 92138-0278, US

(73) Assignee: Nokia Corporation

(21) Appl. No.: 11/683,405

(22) Filed: Mar. 7, 2007

(51) Int. Cl. H04J 3/14

(52) U.S. Cl. 370/221

(57) ABSTRACT

An improved system and method for repairing and/or retrieving lost or crushed data, such as files carried by the FLUTE protocol, by using a P2P network in wireless digital broadcast networks. According to various embodiments, when a peer device has failed to receive a data packet from operator, or when a data packet contains errors, the peer device sends a Search request to neighboring devices. The neighboring devices can either return the data packet in integrated form to the peer device or, if they do not possess the data packet in integrated form, reroute the request to other devices. Mechanisms are also provided for each peer device to maintain and update a table of neighboring devices including an identification of the devices and their connection capabilities.

### FIELD OF THE INVENTION

The present invention relates generally to the use of digital broadcasting technologies for broadcasting data. More particularly the present invention relates to repairing broadcast data which has suffered from packet losses and errors, also referred to as crushed data, during transmission using one of various digital broadcast technologies.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In recent years, many wireless digital broadcasting technologies have been developed and deployed. Such digital broadcasting technologies include, but are not limited to, Digital Audio Broadcasting (DAB), Digital Video Broadcasting-Terrestrial (DVB-T), Digital Video Broadcasting-Handheld (DVB-H), DMB-T, a terrestrial digital television standard for the People's Republic of China, Forward Link Only (FLO) and MediaFLO. These technologies and others are primarily intended to be used for audio or/and video broadcasts. In audio and video broadcasting, no return channels, where information is returned to the broadcast source, are typically necessary and therefore have not traditionally been provided for these systems. There is usually no need for return channels because, with many conventional digital broadcasting systems, there is a certain degree of tolerance for packet losses and errors in audio and video transmission. This tolerance arises from the correlation of context frames and codec technologies, meaning that the receiver can ignore lost packets and packets with errors, while still obtaining sufficient data to exhibit the audio and/or video without requiring the retransmission of the lost and/or error-filled data. Therefore technologies like DVB-H are effective and sufficient to broadcast video signals without any return channels.

In recent years, however, the communication industry has determined that these technologies can be used to broadcast, not only audio and video, but also data. For example, Internet Protocol Datacasting (IPDC) opens a new mobile broadband distribution channel to content providers with limited additional costs. However IPDC requires that return messages be at least selectively transmitted to the broadcast server. This is due to the fact that there is a large amount of loss-sensitive data in items such as files and web pages. If these sensitive data packets are lost or possess errors, these the items can become unusable and/or hopelessly corrupted unless the receiver is able to either reconstruct the lost packets or crushed packets by themselves or request that the packets at issue be resent by the server or other sending device.

Although various mechanisms exist for a device to request the resending of certain packets of data, each has its own drawbacks. These mechanisms include asynchronous layered coding (ALC), negative acknowledge (NACK)-Oriented Reliable Multicast (NORM) Building Blocks (available at www.ietf.org/rfc/rfc3941.txt, incorporated herein by reference), a combination of ALC and NORM (as discussed in United States Application Publication No. 2005/160345, the content of which is incorporated herein by reference), and HTTP-based rerequest systems described in the content delivery protocols (CDP). The CDP specifications published at www.dvb-h-online.org and incorporated herein by reference are maintained by the DVB Project Office. The CDP specifications disclose a method of repairing crushed data that has been previously broadcast. These protocols use return channels to enable an IPDC client to transmit repair requests after a random back-off time to a repair server that randomly selected by the client from a repair server list for downloading the correct data block by HTTP. This is discussed in detail at ETSI TS 102 472 V1.1.1 (2006-06), “Technical Specification Digital Video Broadcasting (DVB); IP Datacast over DVB-H.”

All of the above systems focus on two primary factors—reducing the retransmission of the crushed/missing data from the broadcast server or other sending device to promote overall network efficiency, and reducing request package transmission to the repair server or other sending device to avoid overloading the repair server or causing “NACK-implosion” or congestion of the network. However, all of these systems have certain shortcomings. For example, ALC is generally not considered to be a reliable mechanism, and NORM is not applicable in the wireless environment because of the “NACK-implosion” issue. In CDP, the broadcast server will not re-transmit or re-broadcast the crushed/missing data at all, and each receiving device will wait a random period of time to send an HTTP request to the repair server in order to avoid overloading the repair server or causing excess congestion of the network. In any event, however, each receiving device must still send a request to the repair server. In United States Application Publication No. 2005/160345, the receiving device which received a crushed or missing data block will first check whether its neighbor obtained an integrated block by sending a NACK message. If none of its neighbors received a integrated data block, then the NACK message is transmitted to the sending device. However, one NACK message for each receiving device is sent in this scenario, resulting in the “NACK-implosion” issue discussed above.

In light of the above difficulties, it would therefore be desirable to provide an improved system for repairing broadcast data while addressing the issues discussed above.

### SUMMARY OF THE INVENTION

Various embodiments of the present invention provide an improved system and method for repairing and/or retrieving lost or crushed data, such as files carried by the File Delivery Over Unidirectional Transport (FLUTE) protocol, by using a Peer-to-Peer (P2P) network in wireless digital broadcast networks such as DVB-H. In the various embodiments, a broadcast receiver receives data from the network and repairs crushed data or receives lost data through the use of a P2P network which is formed by peers—broadcast receivers in the same network which are interconnected wiredly or wirelessly through Bluetooth, Wi-Fi, cable or other systems. All receiving devices may join the P2P network in order to repair their crushed data block(s), to find their missing data block(s) or, as necessary or desired, to broadcast their own integrated data block(s). With this routing system, only one receiving device needs to obtain an integrated data block in order to enable all of its neighbors and its neighbor's neighbors, etc. to obtain the data block without having to connect to a repair server or to request the retransmission of the data block from the sending device, thereby eliminating the problem of NACK-implosions, as well as eliminating the need for additional infrastructure for repairing crushed data.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a network environment for a P2P network within which various embodiments of the present invention may be implemented;

FIG. 2 is a representation showing how a crushed data block can be repaired by utilizing a P2P network in accordance with various embodiments of the present invention;

FIG. 3 is a representation showing how a table carrying information on neighboring devices can be maintained and updated so that individual peer devices can keep track of available neighboring devices which can share data packets which have been lost and/or crushed in transmission;

FIG. 4 is a representation of the structure of a search message transmitted by a peer device when searching for an integrated data block;

FIG. 5 is a representation of the structure of a return message transmitted by a peer device in response to a received search message when the peer device possesses an integrated data block identified in the search message;

FIG. 6 is a representation of the structure of a message transmitted by a peer device to indicate the peer device's connection capabilities;

FIG. 7 is a representation of a peer device's table carrying information on neighboring devices, including connection information for each of the device's neighboring peer devices;

FIG. 8 is a perspective view of a mobile telephone that can be used in the implementation of the present invention;

FIG. 9 is a schematic representation of the telephone circuitry of the mobile telephone of FIG. 8.

### DETAILED DESCRIPTION OF VARIOUS EMBODIMENTS

Various embodiments of the present invention provide an improved system and method for repairing and/or retrieving lost or crushed data, such as files carried by the FLUTE protocol, by using a P2P network in wireless digital broadcast networks such as DVB-H (The FLUTE protocol is disclosed in detail at http://www.ietf.org/rfc/rfc3926.txt, the content of which is incorporated herein by reference in its entirety). In the various embodiments, a broadcast receiver receives data from the network and repairs crushed data or receives lost data through the use of a P2P network which is formed by peers—broadcast receivers in the same network which are interconnected through Bluetooth, Wi-Fi, cable or other systems. All peer devices may join the P2P network in order to repair their crushed data block(s), to find their missing data block(s) or, as necessary or desired, to broadcast their own integrated data block(s). With this routing system, only one peer device needs to obtain an integrated data block in order to enable all of its neighbors, its neighbor's neighbors, their neighbors, etc. to obtain the data block without having to connect to a repair server or to request the retransmission of the data block from the sending device, thereby eliminating the problem of NACK-implosions.

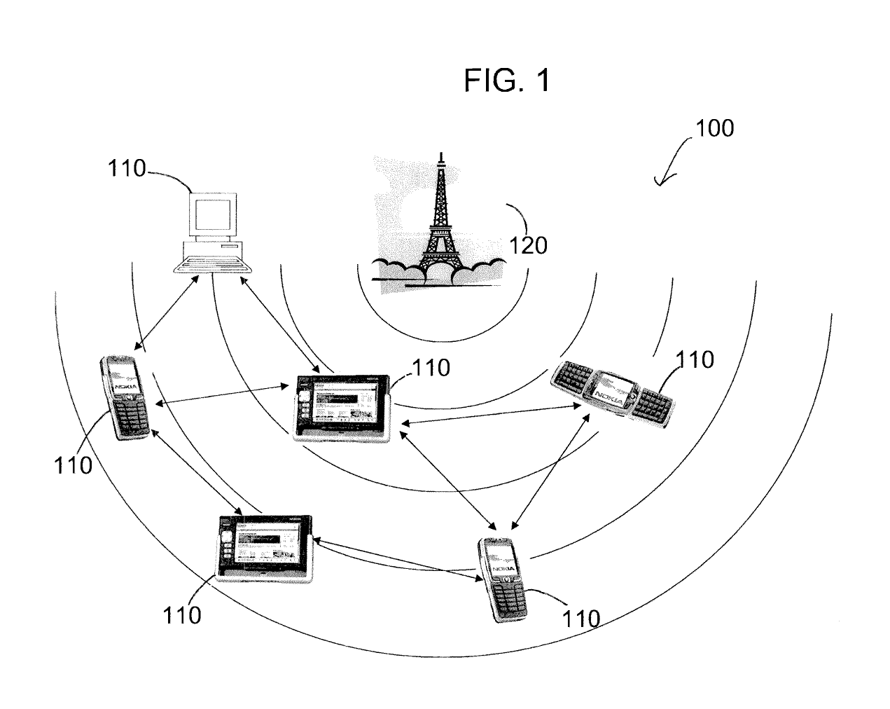

FIG. 1 is a depiction of the architecture P2P repair network 100 constructed in accordance with various embodiments of the present invention. The P2P repair network comprises a plurality of peer devices 110. The peer devices 110 can take a variety of forms, including but not limited to mobile telephones, combination personal digital assistant (PDA) and mobile telephones, PDAs, integrated messaging devices (IMD), desktop computers, and notebook computers. The various receiving devices can communicate with each other over a variety of mechanisms, including but not limited to cable, Bluetooth, wireless local area network (WLAN) and infrared connections. Each peer device 110 is capable of receiving a plurality of data blocks from a network operator 120, such as a DVB-T/H, T-DMB, DMB-T, ATSC, FLO/MediaFLO, and/or Mobile Multimedia Broadcasting operator, Multimedia Broadcast Multicast Service (MBMS) of 3GPP and/or Broadcast and Multicast Services (BCMCS) of 3GGP2.

In particular embodiments of the present invention, each peer device 110 includes software that is used to perform several processes. In addition to constructing messages for exchanging with other peer devices 110, the software may be used for crush detecting. In particular, when a respective peer device 110 is receiving broadcast data blocks, the software is capable of identifying which data block is crushed by specifying the identifier of the crushed data block (as used herein, “crushed” refers to both blocks containing errors and missing blocks). When such a block is identified, the software can then construct and flood a “Search” message as discussed below.

Software within the peer device 110 may be used for routing purposes. More particularly, software can enable each peer device 110 to route search and messages. (These messages are referred to in the examples herein as Search and Return messages, respectively.) When such messages are received by a peer device 110, the peer device 110 can decide whether to modify, forward and/or discard the message depending upon the message's content and the peer device's own situation. For example, if the peer device 110 that receives the Search message does not have a complete and error-free (integrated) data block that was requested in the message, then it can forward the Search message to its own neighbor devices. On the other hand, the message would not be forwarded if the peer device 110 had the requested integrated data block, instead sending a Return message including the requested data block.

Still further, software within each respective peer device 110 may also be used for maintenance purposes, particularly neighbor connectivity maintenance. As discussed in detail below, each peer device 110 maintains a table containing information about each neighboring peer device 110, such as device connectivity capabilities. This table, which is referred to in the examples herein as a Neighbors table, is updated by exchanging messages among the respective peer devices 110. Two methods may be used to exchange this message. In the examples herein, these messages are referred to as YourNeighbor messages. One method involves the use of a regular “heartbeat” system to exchange YourNeighbor messages with neighboring peer devices 110. Another method involves sending YourNeighbor messages whenever a Search message is received.

A variety of methods may be used by peer devices 110 to detect crushed data packets. One such option involves the use of a cyclic redundancy check (CRC), as defined by CCITT, an organization now known as the International Telecommunications Union (ITU). Using CRC, transmitted packets are divided into predetermined lengths that are divided by a fixed divisor. Using CRC-CCITT, a source symbol “123456789” has a corresponding CRC code of 0xE5CC. This information is transmitted to the respective peer devices 110, and the peer devices 110 simply have to calculate the remainder of the source symbol. If there is a remainder, the data packet's FEC Payload ID can be used to identify the data block at issue. The Network Working Group's Request for Comments 3453, which can be found at www.ietf.org/rfc/rfc3453.txt (the contents of which are incorporated herein by reference), discusses the use of forward error correction (FEC) in reliable multicast environments. FEC Payload Blocks are discussed in the Network Working Group's Request for Comments 3452, which can be found at www.ietf.org/rfc/rfc3452.txt (the contents of which are incorporated herein by reference) www.ietf.org/rfc/rfc3452.txt.

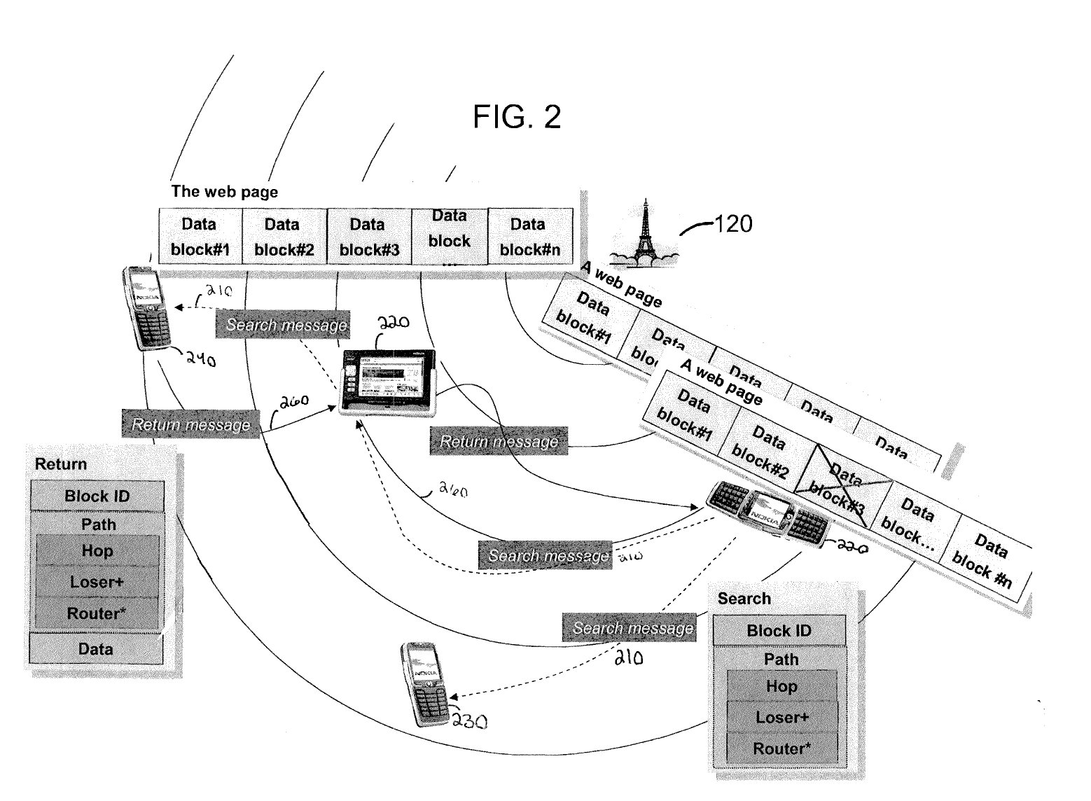

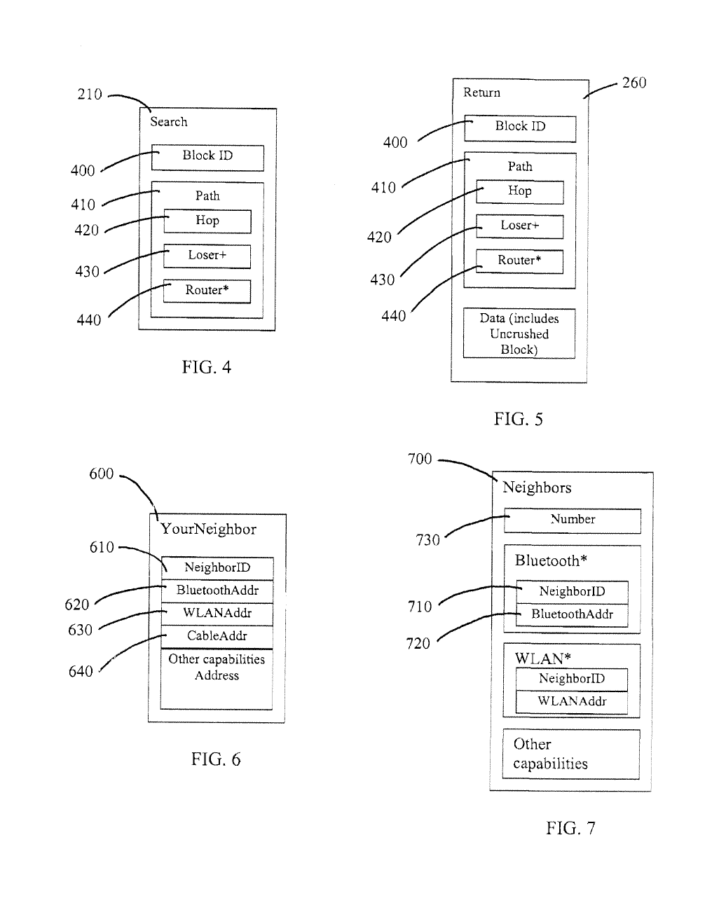

FIG. 2 is a representation showing how a crushed data block can be repaired by utilizing a P2P network in accordance with various embodiments of the present invention. In FIG. 2, the network operator 120 has broadcast a plurality of data blocks. One of these blocks, identified as Block #3 in FIG. 2, is received in crushed form by a first peer device 200, meaning that the data block contains errors of some form. In response to detecting the crushed block, the first peer device 200 transmits Search messages, represented at 210, to first and second neighboring peer devices 220 and 230, as identified in the first peer device's Neighbors table. In other words, the first peer device 200 transmits Search messages to all peer devices which are identified by the first peer device's Neighbors table as being neighboring devices. As depicted in FIG. 4, the Search message includes an ID of the crushed data block, the identity of the first peer device 200, routing information for the first peer device 200, and other information as necessary.

FIG. 4 is a representation of an individual Search message 210. In the Search message 210, the “BlockID” is a unique identifier for the desired data block. In one particular embodiment, the “BlockID” 400 refers specifically to an FEC Payload ID that is transferred using the FLUTE protocol. This value can be taken from the header field of an ALC packet, as described in the Network Working Group's Request for Comments 3450, which can be found at www.ietf.org/rfc/rfc3450.txt (the contents of which are incorporated herein by reference). The “Path” information 410 may contain one or more “Hop,” “Loser” and “Router” elements. The “Hop” information 420 in the Search message 210 is a value that is initially set to zero by the message constructor. This value is incremented by one by each peer device that routes/forwards the Search message 210. The “Loser” information 430 refers to peer devices that have routed a Search message 210 with the “BlockID” 400 of the data block that has been requested. In other words, each device that routed the Search message 210, in addition to the originator, will be identified in the “Loser” information 430. The “Router” information 440 includes information concerning the path which was taken by the Search message 210. The Search message 210 can also include “Method” information (not shown) for identifying a connection mechanism (e.g., BlueTooth, WLAN, Infrared, Cable, etc.) to be used when transmitting messages.

The Document Type Definition (DTD) definition of a Search message 210, expressed using Extended Markup Language (XML) according to one embodiment of the invention, is as follows:

<!-- Root element -->
<!ELEMENT Search (BlockID, Path)>
<!ELEMENT BlockID (#PCDATA)>
<!ELEMENT Path (Hop, Loser+, Router*)>
<!ELEMENT Hop (#PCDATA)>
<!ELEMENT Loser (Cap*)>
<!ELEMENT Router(Cap*)>
<!ELEMENT Cap (LoserID, Method)>
<!ELEMENT LoserID (#PCDATA)>
<!ELEMENT Method (#PCDATA)>
<!--End of DTD -->

In the above “LoserID” is an identifier (for example, the IP address or URI) of the respective peer device 110. #PCData (Parsable Character DATA) is XML data that is parsed and rendered.

Referring again to FIG. 2, in the case of the second neighboring device 220, this device has other devices listed in its own Neighbors table and, as such, is capable of relaying the search message to a third neighboring peer device 240. Additionally, in the event that the second neighboring device 220 also received the same data block in crushed form, then it can add its identity to the Search message so that it also receives the uncrushed data block when it is found. All devices possessing Neighbors tables are capable of relaying the Search message as necessary.

In the case of the third neighboring device 240 in FIG. 2, this device possesses an uncrushed, integrated Data Block #3. Therefore, it responds to the relayed Search message 210 with a Return message 260. The Return message 260, which is depicted in FIG. 5, includes the integrated data block 500 that was being searched for, in addition to other information which is similar in nature to that depicted in FIG. 4. The route information may be acquired by parsing the received Search message 210. In the environment depicted in FIG. 2, the Return message is sent back to the first neighboring device 220 and is relayed to the first device 200.

The DTD definition of the Return message 260, according to one embodiment of the invention, is as follows:

<!-- Root element -->
<!ELEMENT Return (BlockID, Path, Data)>
<!ELEMENT BlockID (#PCDATA)>
<!ELEMENT Path (Hop, Loser+, Router*)>
<!ELEMENT Data (#PCDATA)>
<!ELEMENT Hop (#PCDATA)>
<!ELEMENT Loser (Cap*)>
<!ELEMENT Router(Cap*)>
<!ELEMENT Cap (LoserID, Method)>
<!ELEMENT LoserID (#PCDATA)>
<!ELEMENT Method (#PCDATA)>
<!--End of DTD -->

In various embodiments, the Search 210 message and the Return message 260, along with the desired data blocks, can be routed via one or more paths comprising one or more connection types depending on the capabilities of each device on the routing path. When multiple connection types are available, the selection of a particular connection type can be controlled by the peer device 110 itself and, also in one embodiment, a user interface may be provided to give the user opportunity to control which type of connection is used. The desired path can be identified with “Path” information 410 contained within the respective Search 210 message and the Return message 260. In other embodiments, users can be provided with the opportunity to “turn on” or “turn off” the routing function of their peer device 110.

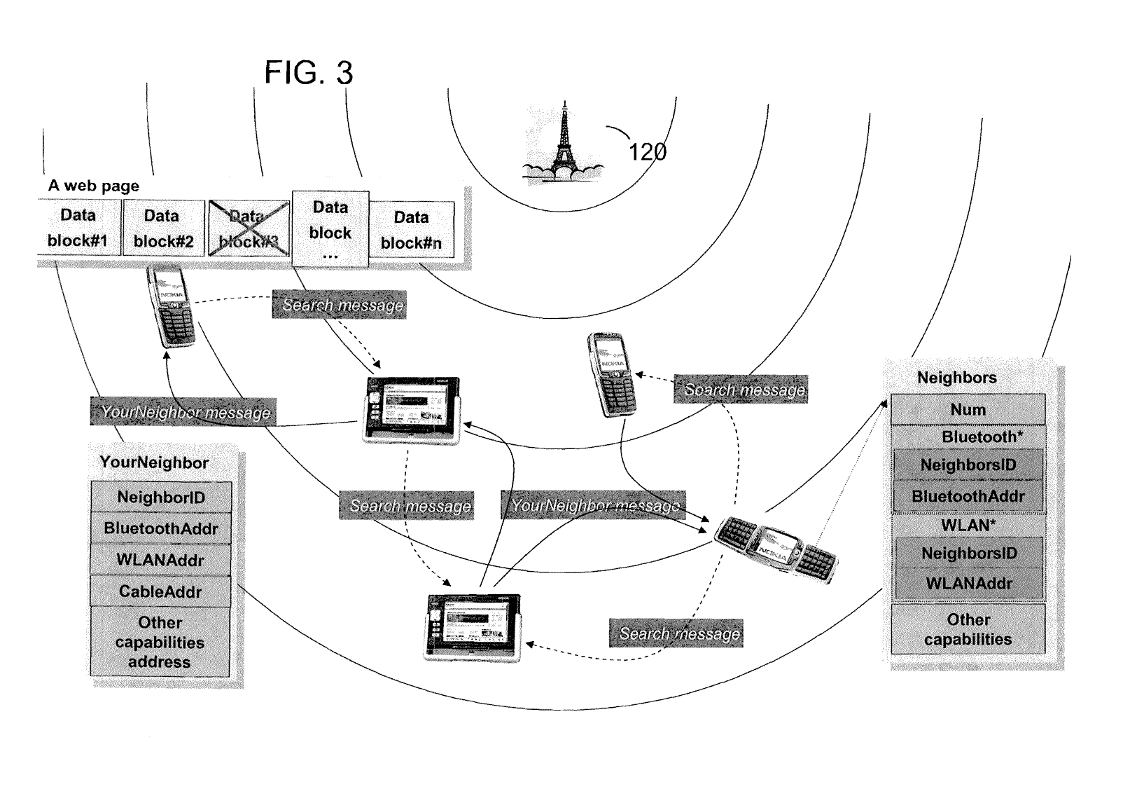

FIG. 3 is a representation showing how various peer devices exchange information about their capabilities to other peer devices in accordance with one embodiments of the present invention. In the embodiment depicted in FIG. 3, any time that a peer device 110 receives a Search message 210, it responds to the peer device from whom it received the Search message with a YourNeighbor message 300. Unlike Search and/or Return messages, YourNeighbor messages 300 are only exchanged between neighboring peer devices and are not rerouted.

The structure of a generic YourNeighbor message 600 is depicted in FIG. 6. A “NeighborID” 610 includes an identification for the peer device 110 that is sending the YourNeighbor message 300. In addition, the YourNeighbor message 300 also includes addresses for the peer device 110 for each of its respective connection capabilities. For example, if the peer device 110 is capable of transmitting and receiving messages via BlueTooth, WLAN and Cable, then the YourNeighbor message 300 includes addresses information in the “BluetoothAddr” 620, “WLANAddr” 630, and “CableAddr” 640.

The DTD definition of the YourNeighbor message 300, according to one embodiment of the invention, is as follows:

<!-- Root element -->
<!ELEMENT YourNeighbor(NeighborID, BluetoothAddr*,
InfraredAddr*, CableAddr*)>
<!ELEMENT NeighborID (#PCDATA)>
<!ELEMENT BluetoothAddr (#PCDATA)>
<!ELEMENT InfraredAddr (#PCDATA)>
<!ELEMENT CableAddr (#PCDATA)>
<!--End of DTD -->

Whenever a peer device 110 receives a YourNeighbor message 300, it automatically updates its own Neighbors table, which is generically represented at 700 in FIG. 7. The Neighbors table includes, for each connection mechanism (e.g., BlueTooth, WLAN, etc.), an identifier and address for each capable neighboring peer device. For example, for BlueTooth-capable devices, there is a specific “NeighborsID” 710 and “BluetoothAddr” location 720 in the Neighbors table 700, while the same information for WLAN-capable devices is maintained separately in the Neighbors table 700. The Neighbors table 700 also includes a “Num” element 730, which indicates the number of the device's neighbors in which its connection data is stored.

The DTD definition of the Neighbors table 700, according to one embodiment of the invention, is as follows:

<!-- Root element -->
<!ELEMENT Neighbors (Num, Bluetooth*, Infrared*, Cable*)>
<!ELEMENT Num (#PCDATA)>
<!ELEMENT Bluetooth (NeighborID, BluetoothAddr+)>
<!ELEMENT Infrared (NeighborID, InfraredAddr+)>
<!ELEMENT Cable (NeighborID, CableAddr+)>
<!ELEMENT NeighborID (#PCDATA)>
<!ELEMENT BluetoothAddr (#PCDATA)>
<!ELEMENT InfraredAddr (#PCDATA)>
<!ELEMENT CableAddr (#PCDATA)>
<!--End of DTD -->

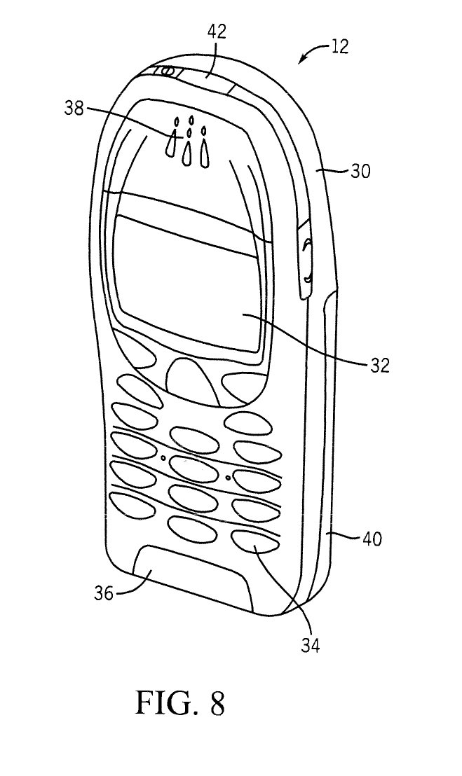

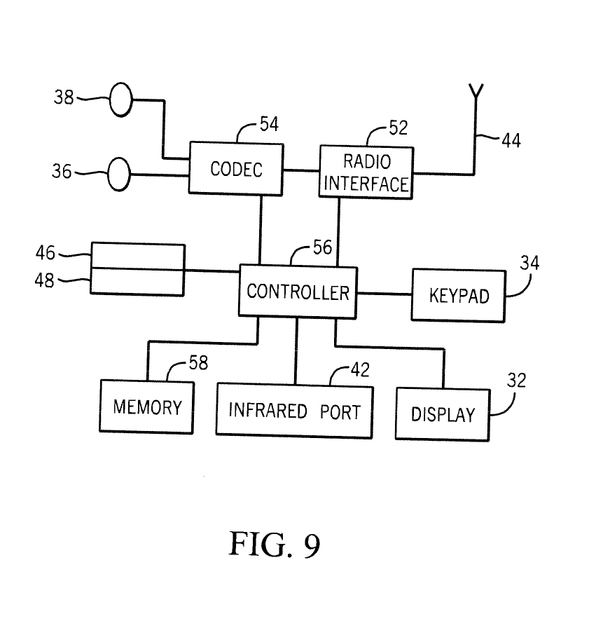

FIGS. 8 and 9 show one representative mobile telephone 12 within which the present invention may be implemented. It should be understood, however, that the present invention is not intended to be limited to one particular type of mobile telephone 12 or other electronic device. The mobile telephone 12 of FIGS. 8 and 9 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

To the extent that individual references, including issued patents, patent applications, and non-patent publications, are described or otherwise mentioned herein, such references are not intended and should not be interpreted as limiting the scope of the following claims.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method, comprising:
in response to determining that a desired data packet originating with an operator has either not been received or was received in a form including at least one error, accessing a table indicating the identity of at least one neighboring peer device in a peer to peer network;
transmitting a search message to one or more neighboring peer devices identified in the table, the search message including an identification of the desired packet.

2. The method of claim 1, wherein the search message includes an identification of the peer device that is requesting the desired data packet.

3. The method of claim 1, wherein the search message includes updatable information regarding the route taken by the search message beginning with its initial transmission.

4. The method of claim 1, wherein the search message includes information regarding a desired communication method.

5. The method of claim 1, further comprising receiving a return message from one of the peer devices identified in the table, the return message including the desired data packet.

6. The method of claim 1, further comprising:
receiving an additional message from one or more peer devices, each additional message including identification and connection information for the respective peer device; and
updating the table to reflect the identification and connection information for each peer device.

7. A computer program product, embodied in a computer-readable medium, comprising computer code for performing the processes of claim 1.

8. The computer program product of claim 7, further comprising computer code for processing a received return message from one of one peer devices identified in the table, the return message including the desired data packet.

9. An apparatus, comprising:
a processor; and
a memory unit communicatively connected to the processor and including:
computer code for, in response to determining that a desired data packet originating with an operator has either not been received or was received in a form including at least one error, accessing a table indicating the identity of at least one neighboring peer device in a peer to peer (P2P) network;
computer code for transmitting a search message to one or more neighboring peer devices identified in the table, the search message including an identification of the desired packet.

10. The apparatus of claim 9, wherein the search message includes an identification of the apparatus that is requesting the desired data packet.

11. The apparatus of claim 9, wherein the search message includes updatable information regarding the route taken by the search message beginning with its initial transmission.

12. The apparatus of claim 9, wherein the search message includes information regarding a desired communication method.

13. The apparatus of claim 9, wherein the memory unit further comprises computer code for receiving a return message from one of the peer devices identified in the table, the return message including the desired data packet.

14. The apparatus of claim 9, further comprising:
computer code for receiving an additional message from one or more peer devices, each additional message including identification and connection information for the respective peer device; and
computer code for updating the table to reflect the identification and connection information for each peer device.

15. A method, comprising:
receiving, at a receiving peer device, a search message from a neighboring peer device, the search message including an identification of a data packet which is desired by at least one device;
determining whether the receiving peer device possesses the desired data packet without any errors; and
if the receiving peer device possesses the desired data packet without any errors, transmitting a return message to the neighboring peer device, the return message including the desired data packet.

16. The method of claim 15, further comprising, in response to the received search message, transmitting to the neighboring peer device an additional message, the additional message including identification and connection information for the receiving peer device.

17. The method of claim 15, further comprising, if the receiving peer device does not possess the desired data packet without any errors:
accessing a table identifying at least one neighboring peer device; and
forwarding the search message to one or more neighboring peer devices identified in the table.

18. The method of claim 17, further comprising, if the receiving peer device does not possess the desired data packet without any errors, appending an identification of the receiving peer device to the search message before forwarding the search message.

19. The method of claim 17, further comprising:
receiving the return message including the desired data packet from one of one peer devices identified in the table; and
forwarding the return packet to the neighboring peer device.

20. The method of claim 17, further comprising
receiving an additional message from one or more peer devices identified in the table, each additional message including identification and connection information for the respective peer device; and
updating the table to reflect the identification and connection information for each peer device.

21. The method of claim 15, wherein the search message includes an identification of a device that is requesting the desired data packet.

22. The method of claim 15, wherein the search message includes updatable information regarding the route taken by the search message beginning with its initial transmission.

23. The method of claim 15, wherein the search message includes information regarding a desired communication method.

24. A computer program product, embodied in a computer-readable medium, comprising computer code for performing the processes of claim 15.

25. The computer program product of claim 24, further comprising computer code for, if the receiving peer device does not possess the desired data packet without any errors:
accessing a table identifying at least one neighboring peer device; and
forwarding the search message to one or more neighboring peer devices identified in the table.

26. An apparatus, comprising:
a processor; and
a memory unit communicatively connected to the processor and including:
computer code for processing a received search message from a neighboring peer device, the search message including an identification of a data packet which is desired by at least one device;
computer code for determining whether the apparatus possesses the desired data packet without any errors; and
if the apparatus possesses the desired data packet without any errors, transmitting a return message to the neighboring peer device, the return message including the desired data packet.

27. The apparatus of claim 26, wherein the memory unit further comprises computer code for, in response to the received search message, transmitting to the neighboring peer device an additional message, the additional message including identification and connection information for the apparatus.

28. The apparatus of claim 26, wherein the memory unit further comprises computer code for, if the apparatus does not possess the desired data packet without any errors:
accessing a table identifying at least one neighboring peer device; and
forwarding the search message to one or more neighboring peer devices identified in the table.

29. The apparatus of claim 28, wherein the memory unit further comprises computer code for, if the receiving peer device does not possess the desired data packet without any errors, appending an identification of the receiving peer device to the Search message before forwarding the search message.

30. The apparatus of claim 28, wherein the memory unit further comprises:
computer code for receiving the return message including the desired data packet from one of one peer devices identified in the table; and
computer code for forwarding the return packet to the neighboring peer device.

31. The apparatus of claim 28, wherein the memory unit further comprises:
computer code for receiving an additional message from one or more peer devices identified in the table, each additional message including identification and connection information for the respective peer device; and
computer code for updating the table to reflect the identification and connection information for each peer device.

32. The apparatus of claim 26, wherein the search message includes an identification of a device that is requesting the desired data packet.

33. The apparatus of claim 26, wherein the search message includes updatable information regarding the route taken by the search message beginning with its initial transmission.

34. A system, comprising:
a originating peer device; and
a plurality of neighboring peer devices,
wherein the originating peer device is configured to:
in response to determining that a desired data packet originating with an operator has either not been received or was received in a form including at least one error, access a table indicating the identity of one or more neighboring peer devices; and
transmit a search message to one or more neighboring peer devices identified in the table, the search message including an identification of the desired packet,
and wherein each of the neighboring peer devices is configured to:
process the search message when received from the originating peer device,
determine whether the respective neighboring peer device possesses the desired data packet without any errors; and
if the neighboring peer device possesses the desired data packet without any errors, transmit a return message to the originating peer device, the return message including the desired data packet.

35. The system of claim 34, wherein the neighboring peer devices are each further configured to, in response to the received search message, transmit to the originating peer device an additional message, the additional message including identification and connection information for the receiving peer device, and wherein the originating peer device is configured to, in response to receiving each additional message, update the table to reflect the identification and connection information for each respective neighboring peer device.
